(19) United States
(12) Patent Application Publication
(10) Pub. No.: US 2010/0242829 A1
(43) Pub. Date: Sep. 30, 2010

(54) SYSTEMS AND METHODS FOR MARKING AND DETECTING AN UNDERGROUND UTILITY

(75) Inventor: Martin W. Macey, Draper, UT (US)

Correspondence Address: KIRTON AND MCCONKIE, 60 EAST SOUTH TEMPLE,, SUITE 1800, SALT LAKE CITY, UT, 84111, US

(73) Assignee: INFINITY TIMES INFINITY, LLC, Draper, UT (US)

(21) Appl. No.: 12/622,281

(22) Filed: Nov. 19, 2009

Related U.S. Application Data
(60) Provisional application No. 61/165,040, filed on Mar. 31, 2009.

(51) Int. Cl. G01D 21/00

(52) U.S. Cl. 116/201; 116/209

(57) ABSTRACT

A system for marking and detecting an underground utility is provided. In particular, the present invention relates to a system of risers that are each coupled to an underground utility. Additionally, a free end of each riser is indirectly coupled to an adjacent riser via a colored cable, wherein the colored cable is positioned at a predetermined height above the underground utility. Finally, the color of the cable is selected to visually identify the type of utility to which the system of risers is coupled.

### RELATED APPLICATIONS

This application claims priority to U.S. provisional application Ser. No. 61/165,040, filed Mar. 31, 2009, entitled SYSTEMS AND METHODS FOR MARKING AND DETECTING AN UNDERGROUND UTILITY, which is incorporated herein by reference.

### BACKGROUND OF THE INVENTION

1. Field of the Invention

The present invention relates generally to systems and methods for marking an underground utility. The present invention further relates to systems and methods to permit detection of underground utilities. In particular, at least some embodiments of the present invention relate to a system of risers that are each coupled to an underground utility. Additionally, each riser is indirectly coupled to an adjacent riser via a colored cable, wherein the colored cable is positioned at a predetermined height above the underground utility.

2. Background and Related Art

In recent years, the urban underground has become a web of utility lines, including phones, electricity, gas, cable television, fiber optics, traffic signals, street lighting circuits, drainage and flood control facilities, water mains and waste water pipes. In some locations, major oil and gas pipelines, national defense communication lines, mass transit, and rail and road tunnels also compete for space underground. The deregulation of utility services is adding to the problem as multiple service providers seek to place their networks underground.

Utility lines are all susceptible of being damaged as construction and renovation equipment excavate in their vicinity. Records are often poor with inaccurate utility positions and/or depths. Some live services do not even show on the utility plans. This means that the ability to physically determine on-site the location, nature and depth of underground utility services is critical to reducing the risk and consequence of inadvertent damage during excavation and construction.

Some underground utilities at shallow depths can be located with relative ease using inexpensive equipment, but many types of utilities and especially smaller, non-conducting utilities at greater depths are extremely difficult to locate. For some utilities, damage to a utility line causes interruptions to daily life and commerce. For other utilities, damage can cause physical danger to workers, bystanders and nearby buildings. For all utilities, damage results in expense that is borne by a combination of the contractor, the locating company, utility providers, insurance companies, the affected public and business owners.

In response to these problems, the Federal Laboratory Consortium's State and Local Governments Committee, in conjunction with the Trenchless Technology Center and the Technology Transfer Information Center issued a Statement of Need (SON) for utility locating technologies. Specifically, the SON sought solutions to a problem characterized as “ . . . an issue of significant national importance-the current and increasing potential for damage to underground utility systems caused by excavation and utility installation/repair activities” (Statement of Need: Utility Locating Technologies, http://www.nal.usda.gov/ttic/utilfnl.htm).

Thus, while various devices currently exist for detecting some types of underground utilities, substantial challenges still exist. Accordingly, it would be an improvement in the art to augment or even replace current underground detection systems or techniques with other systems and/or techniques.

### SUMMARY OF THE INVENTION

The present invention relates generally to systems and methods for marking an underground utility. The present invention further relates to systems and methods to permit detection of underground utilities. In particular, at least some embodiments of the present invention relate to a system of risers that are each coupled to an underground utility. Additionally, each riser is indirectly coupled to an adjacent riser via a colored cable, wherein the colored cable is positioned at a predetermined height above the underground utility.

Implementations of the present invention take place in association with both a new underground utility and a previously established underground utility. In some implementations of the present invention, a system of risers is coupled to an outer surface of the underground utility such that the system of risers spans the length of the utility. Additionally, a color coded cable is attached to an extended end of each riser in a continuous manner. The color coded cable interconnects the risers to provide a linked system of risers. In some embodiments, the color of the cable is selected to provide a visual indication of the type of utility to which the system of risers is coupled. In other embodiments, the color of the cable is selected to provide a visual warning regarding the presence of the underground utility.

An underground marking system in accordance with the present invention further includes an attachment system to securely fasten the system of risers to the outer surface of the underground utility. The attachment system may include a strapping device that immobilizes the position of the riser relative to the underground utility.

Some implementations of the present invention further provide means coupling multiple color coded cables to an individual riser. The color coded cable may further include a beaded surface to minimize movement of the cable relative to the stationary position of the riser to which the cable is connected.

An underground marking system in accordance with the present invention may further include a stanchion or extension riser which is coupled to an end of the riser, such that a free end of the stanchion is positioned at or above a ground surface. Some embodiments of the present invention further include a cap that is positioned on a free end of at least one of the riser or stanchion, wherein the cap protects the free end of the riser and/or stanchion. Embodiments of the present invention further include a reflector disposed in a free end of either a riser or a stanchion coupled to a riser. The reflector generally includes materials and/or circuitry that permit surface detection of the reflector via known detection methods. For example, in some embodiments the reflector is visually detectable. In other embodiments, the reflector is detectable via a known detection method, such as sonar, radar, magnetism, radiography, electromagnetic, thermal sensing, geocaching, global satellite positioning, homing signal, dead reckoning, and inertial navigation.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 is a perspective view of an underground utility marking system in accordance with a representative embodiment within the scope of the present invention.

FIG. 2 is a perspective view of a riser in accordance with a representative embodiment within the scope of the present invention.

FIG. 3 is a front view of a riser incorporating a depth gauge in accordance with a representative embodiment within the scope of the present invention.

FIG. 4A is front view of a riser in accordance with a representative embodiment within the scope of the present invention.

FIG. 4B is a side view of the riser shown in FIG. 4A.

FIG. 4C is a perspective view of the riser shown in FIG. 4A coupled to a plurality of underground utilities.

FIG. 5A is a front view of a riser coupled to an underground utility in accordance with a representative embodiment within the scope of the present invention.

FIG. 5B is a top view of the riser shown in FIG. 5A coupled to an underground utility.

FIG. 5C is a perspective view of a riser coupled to an underground utility in accordance with a representative embodiment within the scope of the present invention.

FIG. 5D is a front view of the riser shown in FIG. 5C.

FIG. 5E is a side view of the riser shown in FIGS. 5C and 5D.

FIGS. 5F through 5I are front views of a riser coupled to an underground utility in accordance with a representative embodiment within the scope of the present invention.

FIG. 5J is a front view of a plurality of risers coupled to a large, underground utility in accordance with a representative embodiment within the scope of the present invention.

FIG. 5K is a front view of a plurality of risers coupled to a large, underground utility in accordance with a representative embodiment within the scope of the present invention.

FIG. 6 is a top view of a plurality of risers coupled to an underground utility, where each riser is coupled to an adjacent riser via a colored cable.

FIG. 7 is a top view of a plurality of risers coupled to an underground utility, wherein a plurality of colored cables is positioned along the underground utility in accordance with a representative embodiment within the scope of the present invention.

FIG. 8 is a perspective view of riser having a first end coupled to an underground utility and a second end coupled to a stanchion in accordance with a representative embodiment within the scope of the present invention.

FIG. 9A is an exploded perspective view of a coupling between a riser and a stanchion in accordance with a representative embodiment within the scope of the present invention.

FIG. 9B is an exploded perspective view of a riser and a reflective disk in accordance with a representative embodiment within the scope of the present invention.

FIG. 10A is an underside perspective view of a stanchion and above ground marker in accordance with a representative embodiment within the scope of the present invention.

FIG. 10B is a topside perspective view of the stanchion and above ground marker shown in FIG. 10A.

FIG. 11 is an exploded perspective view of a riser and a cap in accordance with a representative embodiment within the scope of the present invention.

### DETAILED DESCRIPTION OF THE INVENTION

The present invention relates generally to systems and methods for marking an underground utility. The present invention further relates to systems and methods to permit detection of underground utilities. In particular, at least some embodiments of the present invention relate to a system of risers that are each coupled to an underground utility. Additionally, each riser is indirectly coupled to an adjacent riser via a colored cable, wherein the colored cable is positioned at a predetermined height above the underground utility.

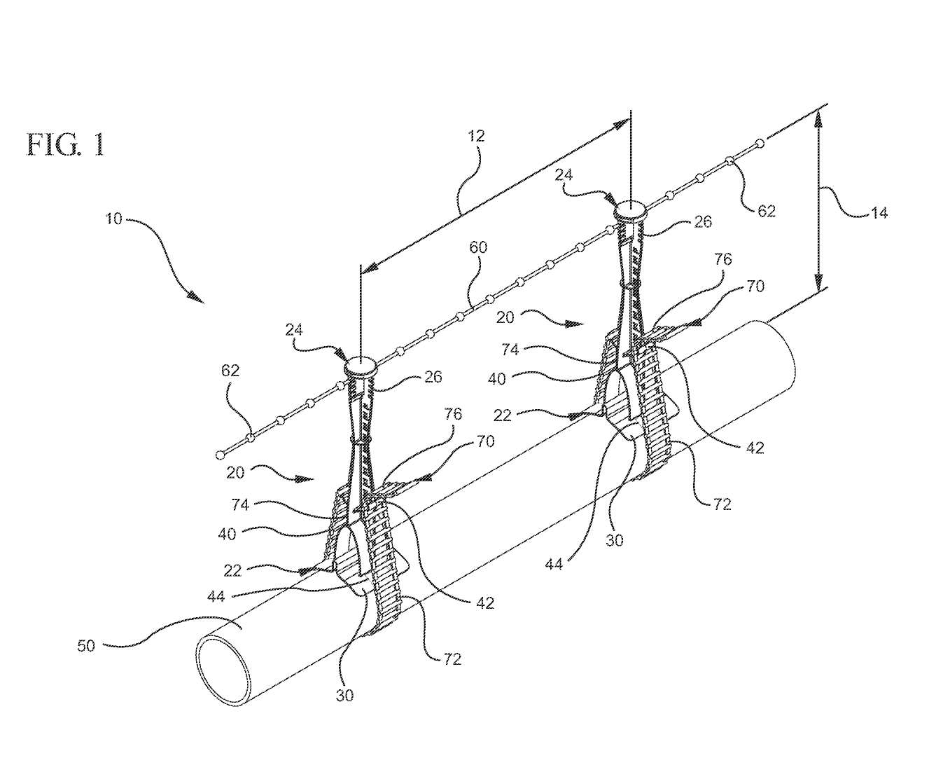

Referring to FIG. 1, an underground marking system 10 for marking an underground utility is shown. An underground marking system 10 generally includes a plurality of risers 20, each riser 20 having a first end 22 and a second end 24. The risers 20 are typically comprised of a non-corrosive, moisture resistant, environmentally compatible material that is capable of being buried underground for an extended period of time. For example, in some embodiments the risers 20 are comprised of non-biodegradable polymer materials, such as nylons, polyvinyl chlorides, polytetrafluoroethylenes, polyesters, polyurethanes, silicones, and other organic and inorganic polymers known in the art. In other embodiments, the risers 20 are comprised of an inert metallic material, such as aluminum, copper, stainless steel, or other metals and metal alloys known in the art. In some embodiments, the risers 20 are comprised of multiple types of materials, each type of material being compatible with the design and use of the underground marking system 10. For example, in some embodiments the risers 20 are comprised of a composite material. In other embodiments, the risers 20 comprise a moisture sensitive material having a moisture resistant coating or covering.

In some embodiments, the risers 20 are positioned adjacent to an underground utility 50 such that the first end 22 abuts a surface of the utility 50, and the second end 24 extends outwardly from the utility 50. The first end 22 is thus configured to compatibly contact an outer surface of the utility 50. For example, in some embodiments the first end 22 includes a saddled surface 30 having a contour that generally minors an outer surface of the utility 50. In other embodiments, the saddled surface 30 is capable of being formed to accommodate an outer surface of the utility 50. In other embodiments, an adapter (not shown) is interposed between the saddled surface 30 and the outer surface of the utility 50, wherein the adapter has a first surface to support the saddled surface 30, and a second surface to support an outer surface of the utility 50.

The saddled surface 30 forms a base portion of the riser 20 and provides a stable interface between the utility 50 and the riser 20. In some embodiments, an interface surface between the saddled surface 30 and the utility 50 further comprises a material to increase a friction coefficient between the saddled surface 30 and the utility 50. For example, in some embodiments the saddled surface 30 includes a rubberized coating. In other embodiments, the saddled surface 30 includes a texture. Finally, in some embodiments the saddled surface 30 includes an adhesive material such as a glue, an epoxy, and/or a cement.

The risers 20 are generally positioned on the underground utility 50 such that a predetermined distance 12 is interposed between adjacent risers 20. Distance 12 may be any distance as selected by a user, or may include a specific distance as mandated by an ordinance or code. For example, in some embodiments distance 12 is selected by a user and is within a range of a few inches to several feet. In other embodiments, distance 12 is mandated by a code such that the distance 12 between each adjacent riser 20 is approximately the same. Still, in other embodiments distance 12 comprises a first value for a first type of utility line, and a second value for a second type of utility line.

In some embodiments of the present invention, a color coded cable 60 is attached to the second end 24 of each riser 20, thereby interlinking each riser 20 with an adjacent riser 20. In some embodiments, the second end 24 of each riser 20 is modified to include a surface or receptacle for engaging a portion of the colored cable 60. For example, in some embodiments the second end 24 of each riser includes a channel, a hook or a clip 26 for receiving a portion of the cable 60. In other embodiments, the second end 24 comprises multiple channels, hooks or clips 26 to receive and coordinate a plurality of color coded cables 60. Finally, in some embodiments the second end 24 of the riser 20 comprises a generally featureless surface (not shown) around which a portion of the cable 60 is wrapped, thereby coupling the cable 60 to the second end 24 of the riser 20. The featureless surface may include a texture, coating or plurality of striations to increase friction between the cable 60 and the riser 20.

The color coded cable 60 may include any non-corrosive, moisture resistant material that is cable of being buried underground for an extended period of time. Furthermore, the color coded cable 60 generally comprises a material that is semi-flexible. In some embodiments, the color coded cable 60 comprises an extruded, non-biodegradable polymer material, such as nylons, polyvinyl chlorides, polytetrafluoroethylenes, polyesters, polyurethanes, silicones, and other organic and inorganic polymers known in the art. In other embodiments, the color coded cable 60 comprises a metallic material, such as aluminum, copper, stainless steel, or other metals and metal alloys known in the art. In some embodiments, the color coded cable 60 comprises multiple types of materials, each type of material being compatible with the design and use of the underground marking system 10. In other embodiments, the color coded cable 60 comprises a moisture sensitive material having a moisture resistant coating or covering.

The color coded cable 60 is generally attached to the second end 24 of each riser 20 at a predetermined height 14 above the underground utility 50. The distance 14 may be any distance as selected by a user, or may include a specific distance as mandated by an ordinance or code. For example, in some embodiments distance 14 is selected by a user and is within a range of a few centimeters to several feet. In other embodiments, distance 14 is mandated by a code such that the distance 14 between the cable 60 and the utility 50 is uniformly spaced along the entire length of the utility 60.

The color of the color coded cable 60 is preferably selected to correspond to and identify the specific type of utility 50 over which the cable 60 is positioned. Utility color codes are commonly used for identifying existing underground utilities in construction areas with the intent of protecting the underground utilities from damage during excavation. The American Public Works Association (APWA) has established Uniform Color Codes for marking underground utilities. These color codes are provided in Table 1.

TABLE 1

| Color | Underground Utility |
|---|---|
| Red | Electric power lines, cables, conduit, and lighting cables |
| Orange | Telecommunications, alarm or signal lines, cables or conduit |
| Yellow | natural gas, oil, steam, or other gaseous or flammable material |
| Green | sewers and drain lines |
| Blue | drinking water |
| Violet | reclaimed water, irrigation, and slurry lines |

In some embodiments of the present invention, a color coded cable 60 is selected and coupled to the second end 24 of the riser 20 such that the color of the cable 60 corresponds to the proper Uniform Color Code of the utility to which the first end 22 of the riser 20 is coupled. In other embodiments, a plurality of color coded cables 60 is selected and coupled to the second end 24 of the risers 20 such that at least one cable having an appropriate uniform color is provided for each utility coupled to the first end 22 of each riser 20. In some embodiments, a cable 60 comprises more than one of the uniform colors whereby multiple underground utilities are identified by a single, multi-colored cable 60. In some embodiment only a portion of the cable 60 is color coded or the cable 60 is intermittently color coded along the length of the cable 60. Finally, in some embodiments an external color indicator, such as color coded tape, tag or wrap (not shown) is coupled to the cable 60 to indicate an associated underground utility.

The color coded cable 60 may further include features to limit the ability of the cable 60 to move relative to the second end of each riser 20. For example, in some embodiments the cable 60 includes a beaded surface 62, wherein beaded portions 62 of the cable 60 comprise a diameter greater than the diameter of the color coded cable 60. Furthermore, the diameter of the beaded portions 62 are greater than the diameter of the channel, hook or clip 26 into which the narrower diameter cable 60 is inserted and/or retained. Thus, while the cable 60 compatibly inserts within the channel, hook or clip 26 of the second end 24, the beaded portions 62 of the cable 60 are prevented from passing through the channel, hook or clip 26. As such, in some embodiments of the present invention the cable 60 is permitted to slide relative to the channel, hook or clip 26 until the point at which the beaded portion 62 of the cable 60 binds against the clip 26. At this point the cable 60 is prevented from further movement in the direction of the beaded portion 62.

The beaded feature 62 of cable 60 prevents cable 60 from being pulled or pushed to a position in which the cable 60 contacts the underground utility 50. Thus, in the event that an object strikes, pulls or pushes the cable 60, the beaded portions 62 of the cable 60 will bind on the channel, hook or clip 26 of the risers 20 resulting in increased resistance or in a breakage of the cable 60. In some embodiments, increased resistance in the cable 60, or breakage of the cable 60 provides a physical or visual indication of the underground utility 50. For example, if a shovel strikes the cable 60 while a person is digging towards the underground utility 50, the person will feel the shovel strike the cable 60 thereby indicating the presence of the utility 50. Additionally, if a shovel bucket of a backhoe strikes the cable 60 while digging towards the underground utility 50, the cable 60 will likely break and be exposed for visual identification to the operator of the backhoe. The visual identification will alert the operator of the presence of the utility 50. Where the cable 60 is color coded, the visual identification will also inform the operator as to the specific type of underground utility.

In some embodiments, the risers 20 further include a strapping or attachment system 70. The attachment system 70 generally comprises a belt or strap 72 configured to securely couple the riser 20 to the underground utility 50. In some embodiments, a first end 74 of the strap 72 is attached to a first strap support 40 of the riser 20. The strap 72 is then looped around the underground utility 50 and a second end 76 of the strap is attached to a second strap support 42. In some embodiments, a universal strap 72 is provided having a single length sufficient to secure the risers 20 to a variety of utilities 50 having various outer diameters and/or shapes. In some embodiments, the strap 72 comprises a rubber or polymeric material compatible with the design and use of the underground marking system 10. For example, in some embodiments the strap 72 comprises an elastic or semi-elastic material. In other embodiments, the strap 72 comprises an inelastic material, such as a nylon webbing material. The first and/or second strap supports 40 and/or 42 may further be modified to include a strap ratchet (not shown) or tie down to compatibly receive and retain the strap 72. Finally, one of ordinary skill in the art will appreciate that various other combinations of strapping materials and retaining devices may be used to accomplish the purposes of the attachment system 70, in accordance with the present invention. For example, in some embodiments an underground utility, such as a pipe, is manufactured to include a plurality of strap supports (not shown) spaced at regular intervals along the length of the utility. Each strap support is configured to permit placement of a riser on the utility thereby eliminating the need of including strap supports on each individual riser.

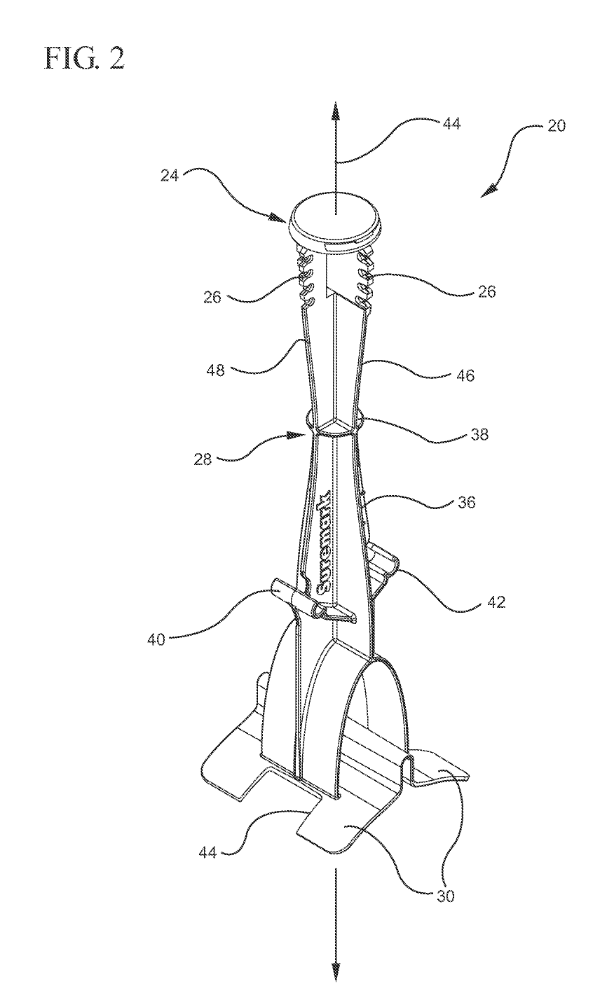

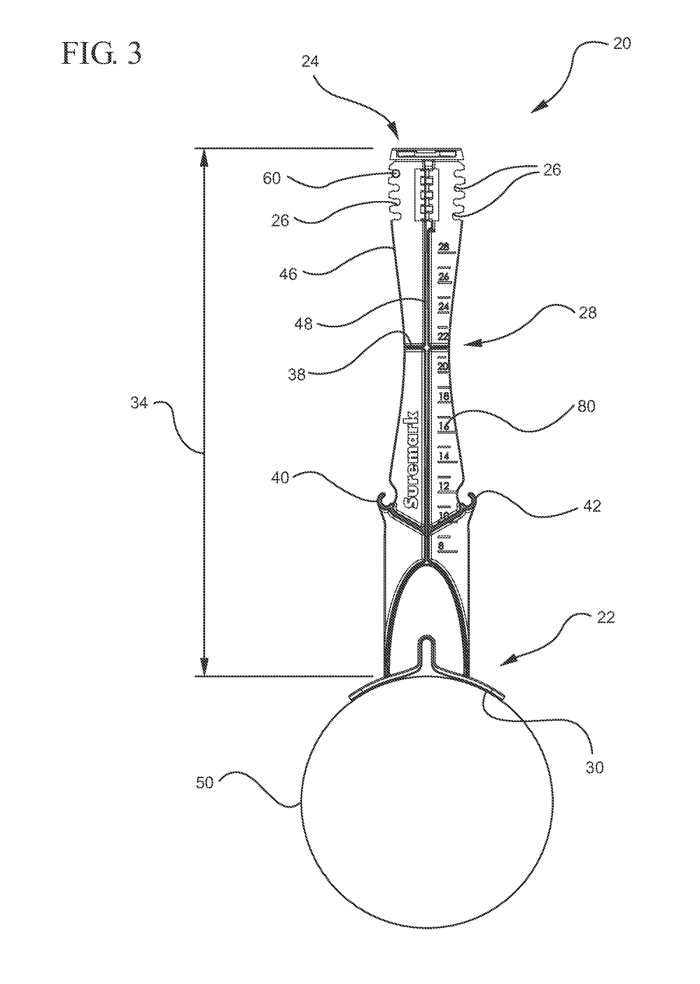

FIGS. 2 and 3 show various views of a riser 20 in accordance with representative embodiments within the scope of the present invention. In some embodiments, the riser 20 further comprises a middle section 28. Middle section 28 defines the portion of the riser 20 interposed between the first end 22 and the second end 24 of the riser 20. Middle section 28 is generally rigid or semi rigid thereby providing structural integrity to the riser 20. In some embodiments, the middle section 28 of riser 20 is ribbed or otherwise flanged 36 to provide lateral support to the riser 20. For example, in some embodiments the middle section 28 includes two flanges 46 and 48 which intersect one another at approximately 90 degrees, thereby providing four individual flanges, each flange extending outwardly from a central axis 44. In some embodiments the middle section 28 of the riser 20 further comprises a divider 38 intersecting the flanged surface 36 to minimize torsional rotation along the length of the riser 20.

Each individual flange is oriented in a direction that is approximately 90 degrees from an adjacent flange. In some embodiments, a portion of each individual flange comprises a clip, channel or hook 26, as previously discussed. Furthermore, in some embodiments each individual flange comprises multiple clips, channels or hooks 26 to support multiple color coded cables 60, as required by the user and/or an ordinance. Thus, in some embodiments each riser 20 is capable of supporting one or more color coded cables in one or more orientations or directions relative to the orientation of the underground utility.

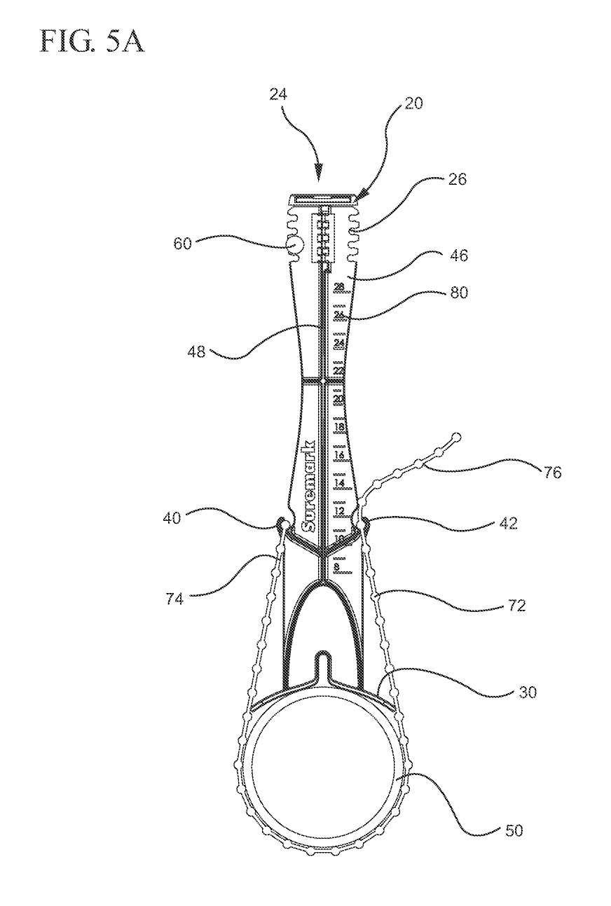

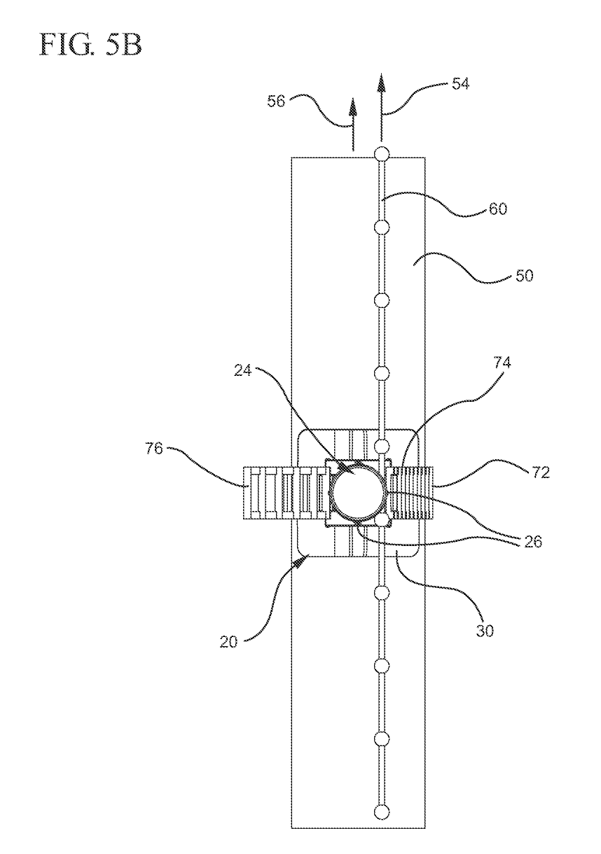

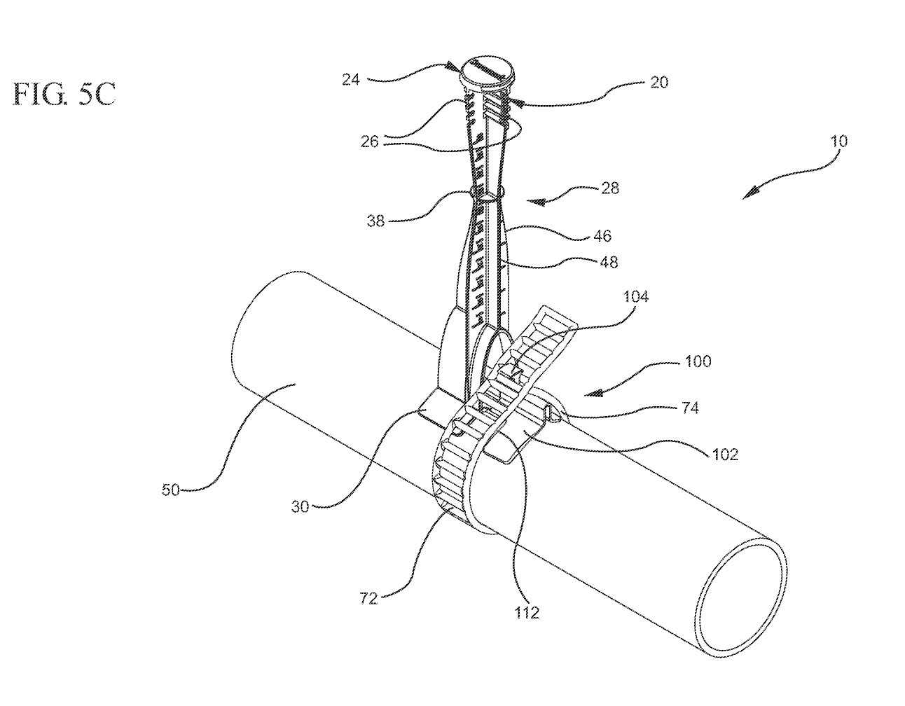

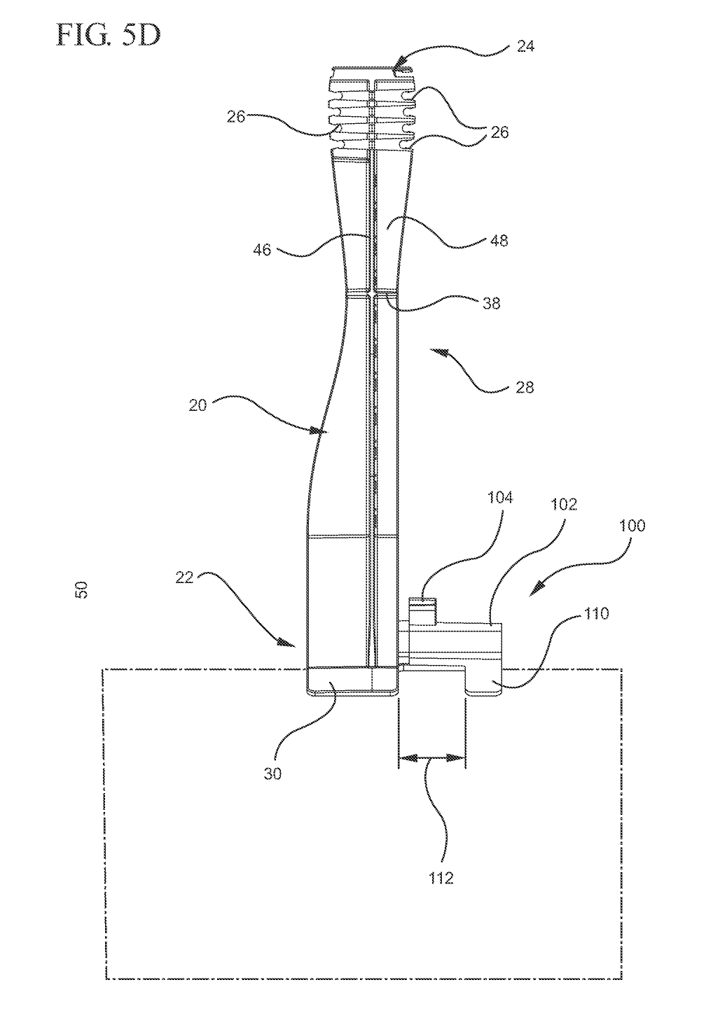

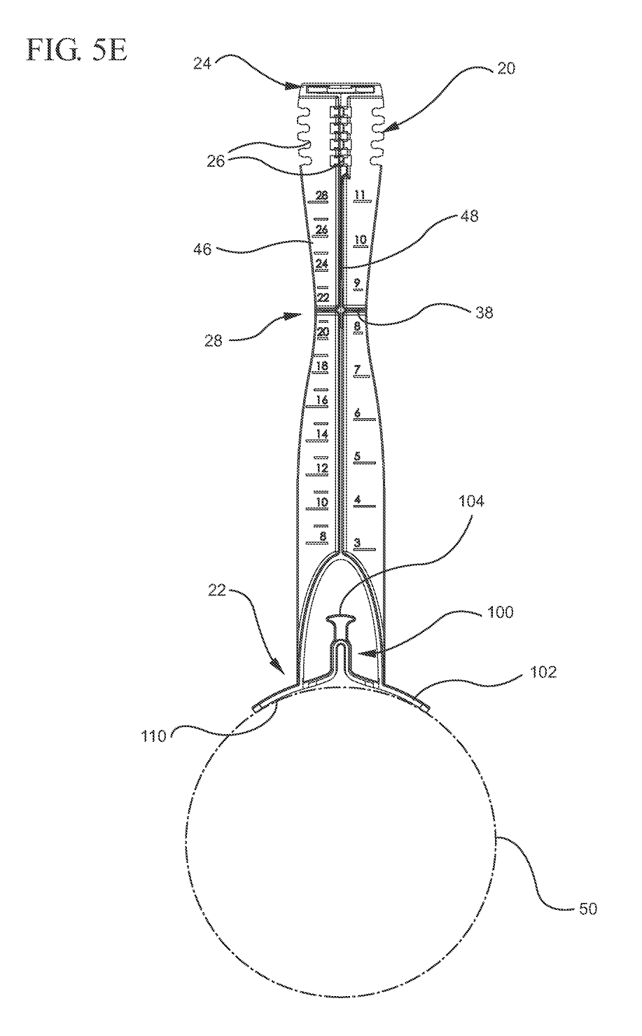

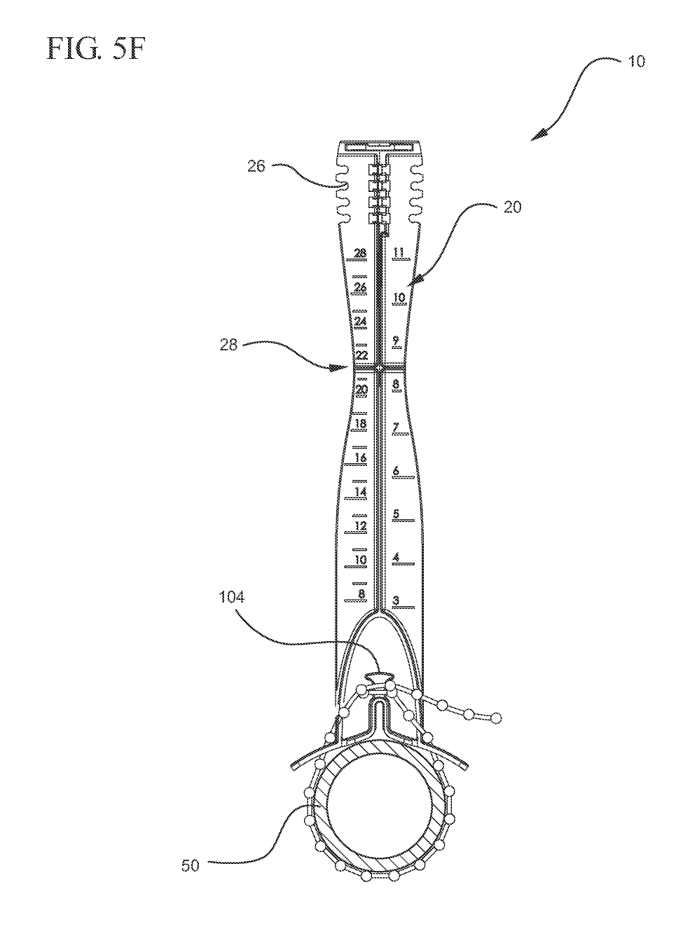

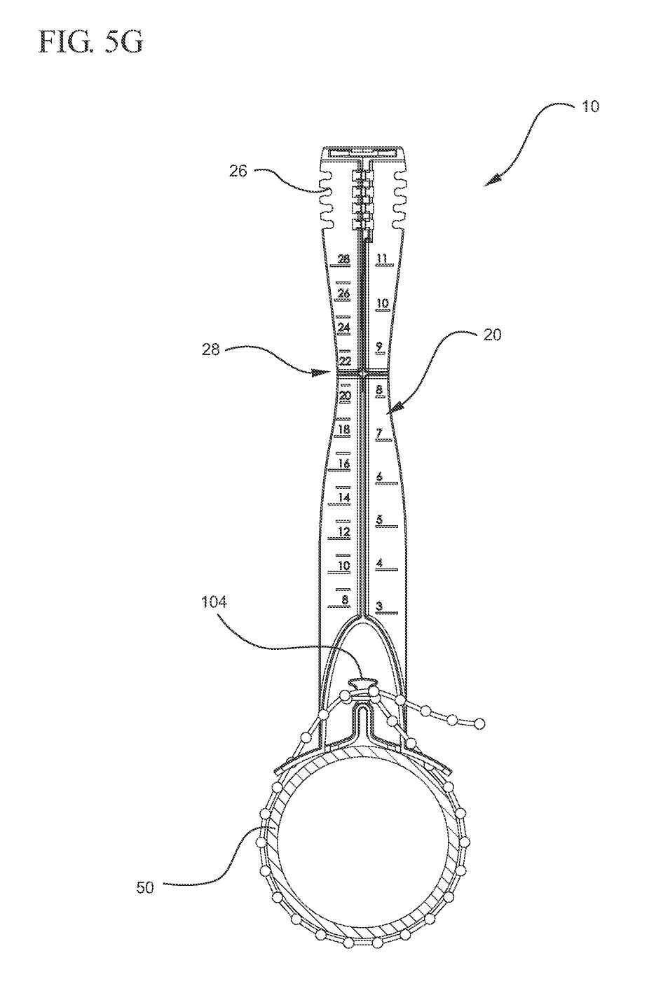

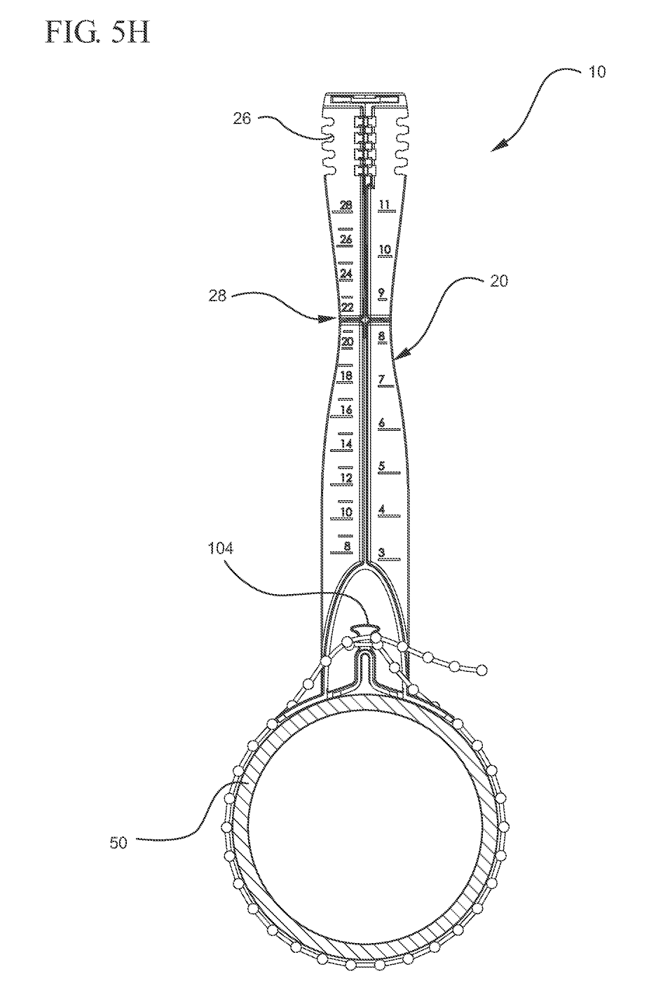

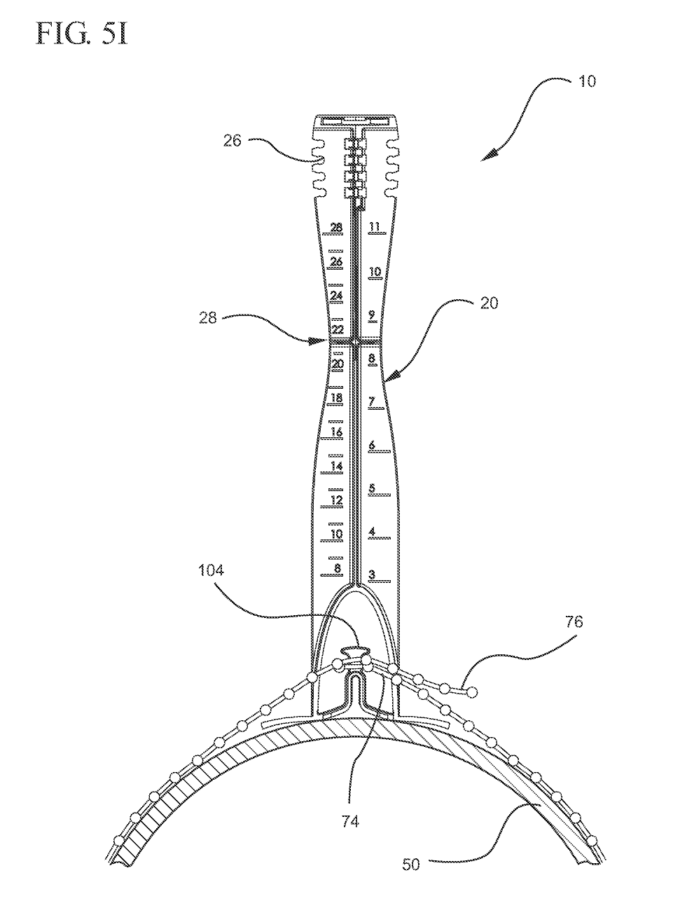

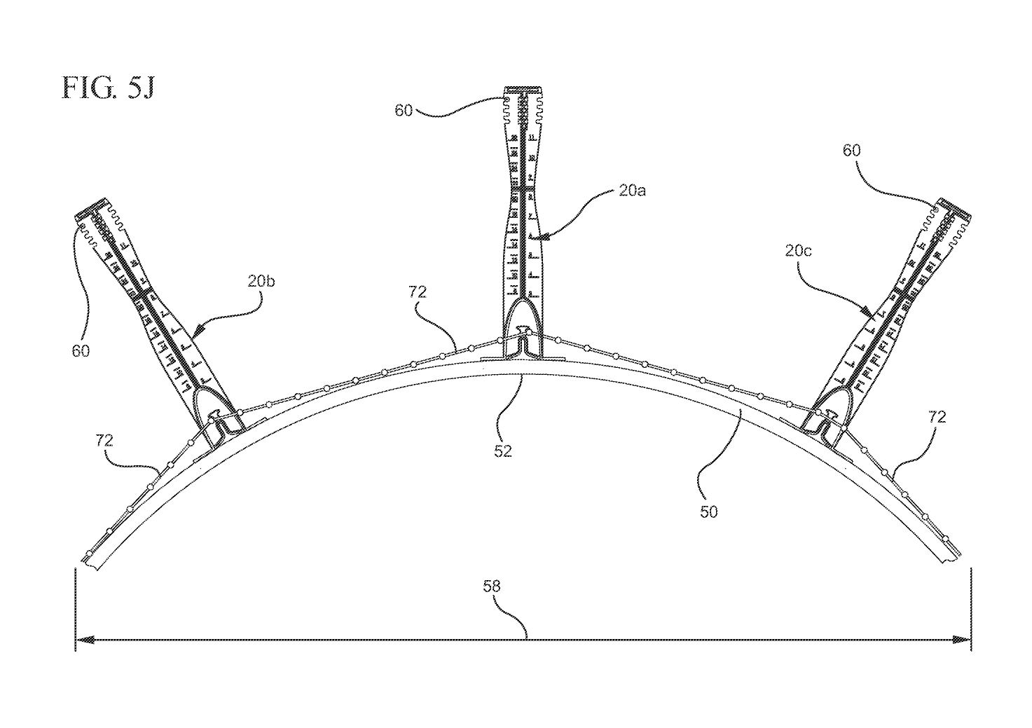

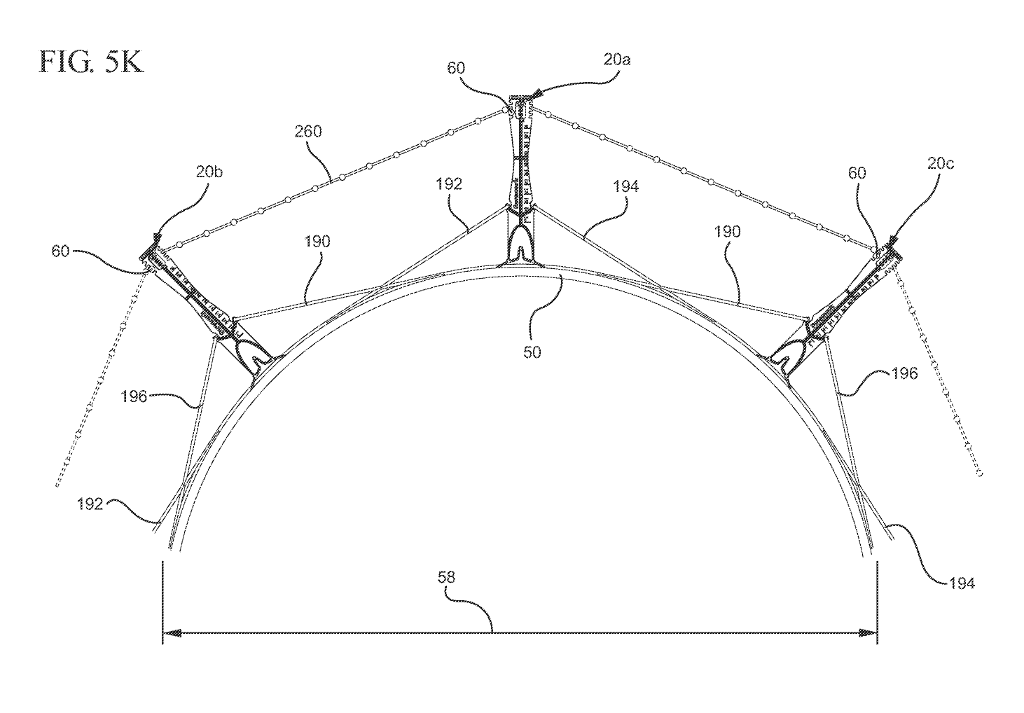

The first and second strap supports 40 and 42 may include any feature of device capable of retaining or securing a strap 72 of the attachment system 70. For example, in some embodiments the middle section 28 of the riser 20 is configured to include opposing hooks or channels which form the first and second strap supports 40 and 42. The hooks or channels are thus configured to retain a first and second end 74 and 76 of the strap 72, as shown in FIG. 1. In some embodiments, saddled surface 30 further comprises a gap 44 in approximate alignment with first and second strap supports 40 and 42. The gap 44 permits a strap 72 to pass through a portion of the saddled surface 30 thereby allowing the riser 20 to attach securely to an underground utility 50 having a width less than the width of the saddled surface 30, as shown in FIGS. 5A, 5F and 5G.

Referring now to FIG. 3, the riser 20 may include features to indicate a depth of the utility 50 relative to the height of the color coded cable 60. For example, in some embodiments the middle section 28 includes a depth scale 80. The depth scale 80 is configured such that a position of the underground utility 50 relative to the middle section 28 of the riser 20 is represented in a scaled format on the middle section 28 of the riser 20. For example, in some embodiments a measurement system of inches or centimeters is displayed on a portion of the middle section 28, where the saddled surface 30 corresponds to a depth of zero, and the second end 24 of the riser corresponds to a depth equal to a height 34 of the riser 20. Thus, when digging toward the underground utility 50, the depth scale 80 indicates the depth of the utility 50 relative to an unburied portion of riser 20.

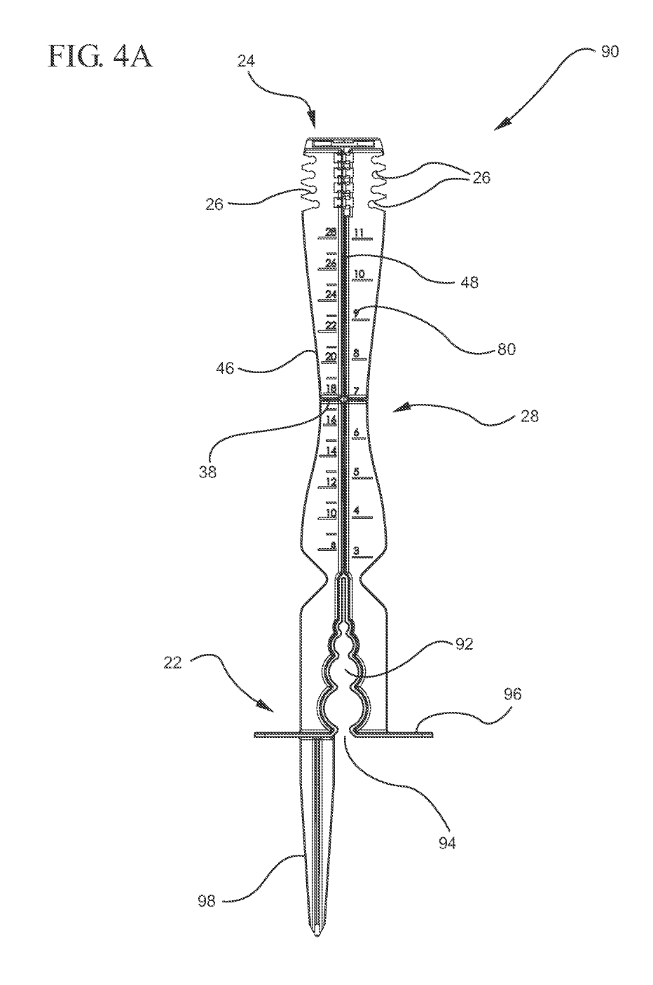

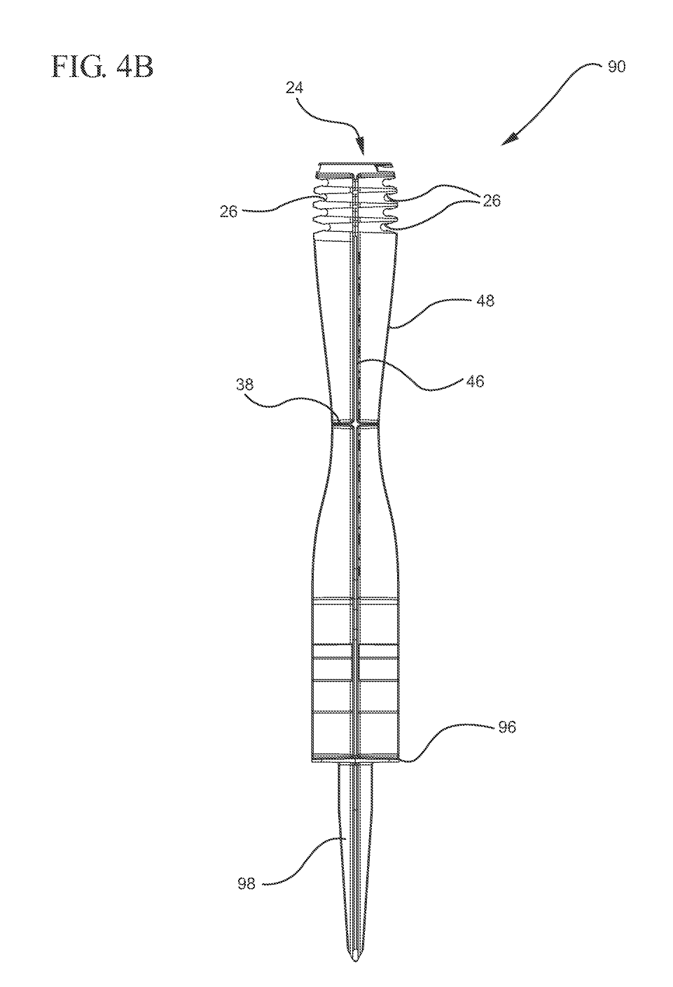

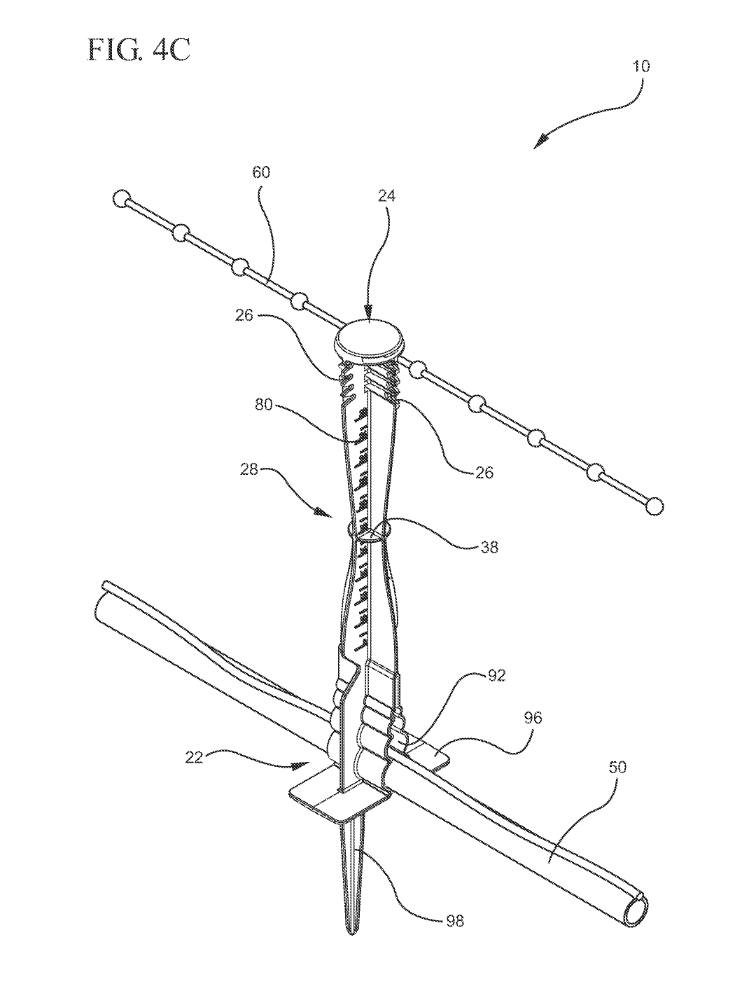

Referring now to FIGS. 4A and 4B, another embodiment of a riser 90 is shown. In some embodiments, the riser 90 includes a channel 92 sized and configured to compatibly receive an underground utility 50. The channel 92 generally comprises an opening 94 located approximate to the first end 22 of the riser 90. The opening 94 generally comprises a width that is less than the outer diameter of the utility 50. As such, the outer diameter of the underground utility 50 is retained within the channel 92 following introduction of the utility 50 through the opening 94. Once the utility 50 is positioned in the channel 92, the utility and riser 90 are securely coupled to one another. In some embodiments, the first end 22 of the riser 90 comprises multiple channels 92. In other embodiments the multiple channels 92 include a plurality of diameters configured to receive one or more utilities 50 having various shapes and/or diameters, as shown in FIG. 4C.

Riser 90 may further include a base platform 96 and an anchoring spike 98. The base platform 96 is provided to support the riser 90 when positioned underground. The platform 96 generally comprises a flange or lateral extension of the first end 22 of the riser 90 to provide a substantial surface area for forming an interface with the adjacent ground. Additionally, when the riser is buried the base platform 96 provides a substantial surface area to further secure and maintain the buried position of the riser 90. The anchoring spike 98 generally comprises a downwardly extended portion of the first end 22. The anchoring spike 98 is provided such that when the riser 90 is secured to the underground utility 50, the spike 98 is driven into the ground below the position of the underground utility 50. As such, the anchoring spike 98 provides lateral and vertical support to further maintain the position of the riser relative to the underground utility 50. In some embodiments, the first end 22 of the riser 90 comprises multiple anchoring spikes 98.

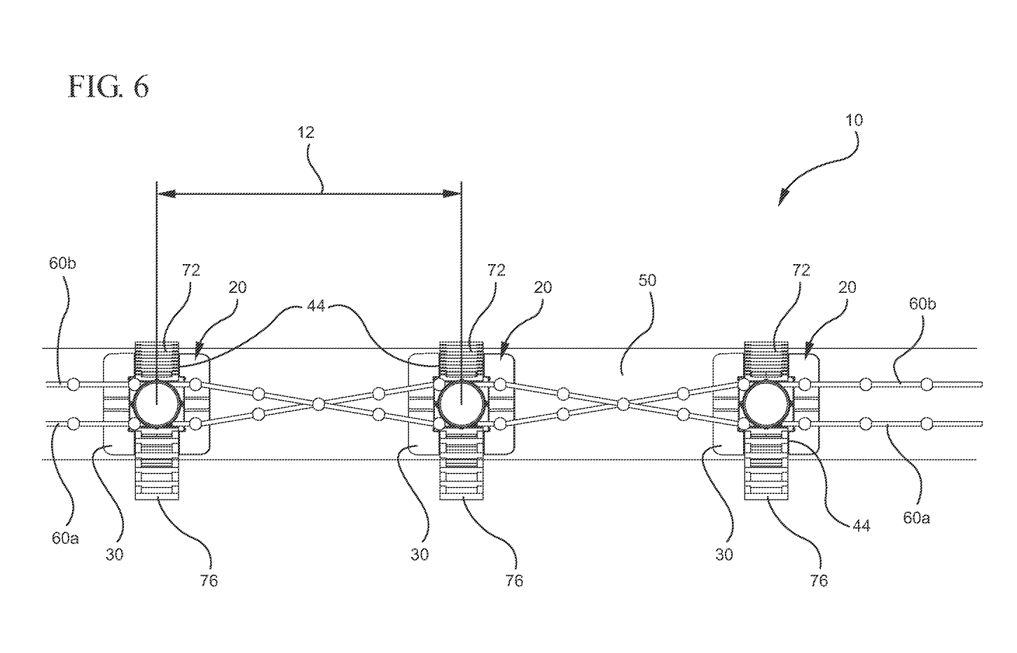

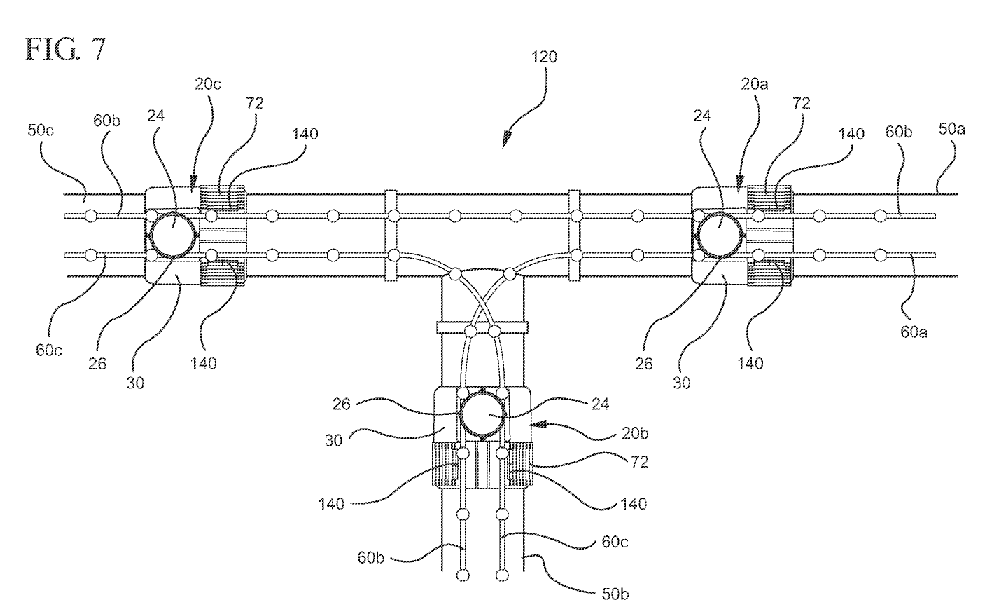

Referring now to FIGS. 5A through 5K, various embodiments of the riser 20 are shown as coupled to an underground utility 50. In general, the color coded cable 60 is secured to the channel, clip or hook 26 of the riser 20 such that an axis 54 of the cable 60 is generally parallel with an axis 56 of the underground utility 50. As such, the direction of the cable 60 approximately corresponds to the direction of the underground utility 50. In some embodiments, a plurality of cables 60 is coupled to each riser 20, as shown generally in FIGS. 6 and 7, below. Referring specifically to FIGS. 5C through 5J, a riser 20 is shown comprising a modified attachment system 100. In this embodiment, a forward portion 102 of the first end 22 is extended outwardly to provide a means for supporting a strap 72. The forward portion 102 comprises a second saddled surface 110 that is configured to form an interface with an outer surface of the underground utility 50. Thus the second saddled surface 102 is used in conjunction with saddled surface 30 to maintain contact with the utility 50.

The modified attachment system 100 further includes a horn 104 protruding upwardly from the forward portion 102 of the riser 20. The horn 104 is configured to include a first surface for retaining a first end 74 of the strap 72 and a second surface for retaining the second end 76 of the strap 72. For example, in some embodiments a first end 74 of a strap 72 is first placed over the horn 104 thereby securing the first end 74 of the strap 72 to the horn 104. The strap 72 is then placed around the utility 50 and the second end 76 of the strap 72 is placed over the horn 104 adjacent to the first end 74 of the strap 72. As such, the strap 72 secures the riser 20 to the underground utility 50. In other embodiments, a portion of the second saddled surface 102 includes a clip, channel or hook for retaining at least the first or second ends 74 and 76 of the strap 72.

In some embodiments, the second saddled surface 110 comprises a gap 112 in approximate alignment with the horn 104. The gap 112 permits a portion of the strap 72 to pass through the second saddled surface 102 thereby allowing the riser 20 to be attached to underground utilities 50 having smaller diameters, as shown in FIGS. 5F through 5H. Additionally, the elevated position of the horn 104 permits the strap 72 to bypass the second saddled surface 102 when the riser 20 is coupled to a utility 50 have a larger diameter, as shown in FIG. 5I.

In some embodiments, multiple risers 20 are positioned across the width 58 of an underground utility 50, as shown in FIGS. 5J and 5K. The width 58 of an underground utility 50 may vary greatly depending upon its type and use. Some underground utilities 50, such as storm drainage pipes can include widths 58 of greater than 3 meters. Therefore, in some embodiment of the present invention a first riser 20a is coupled to the underground utility 50 at a generally centered position 52. Additionally, second 20b and third 20c risers are coupled to the underground utility 50 at positions that are generally to the left and to the right of the first riser 20a. In some embodiments, additional risers (not shown) are further coupled to the underground utility 50 as required to accurately indicate the width 58 of the utility 50. A common strap 72 is then attached to each of the risers and stretched around the utility 50 to secure the positions of the risers 20a, 20b and 20c relative to the utility 50. Thus, for some underground utilities 50, multiple risers 20 may be used to indicate the width 58 of the underground utility 50.

In other embodiments, a plurality of straps is used to interconnectedly secure multiple risers 20a, 20b and 20c across the width 58 of the utility, as shown in FIG. 5K. For example, in some embodiments a first common strap 190 is attached to a first riser 20c and a second riser 20b, wherein a portion of the first strap 190 is routed under an interposed riser 20a. Further, a second common strap 192 is attached to a third riser 20a and a fourth riser (not shown), wherein a portion the second strap 192 is routed under an interposed riser 20b. Finally, a third common strap 194 is attached to a third riser 20a and a fifth riser (not shown), wherein a portion of the third strap 194 is routed under an interposed riser 20c.

In some embodiments, the fourth and fifth risers (not shown) are excluded so that only three, or fewer risers 20 are coupled across the width 58 of the utility 50. In place of additional risers, the second and third straps 192 and 194 are combined into a single strap having a length sufficient to circumscribe the diameter of the utility 50. An additional strap 196 is then coupled to the first and second risers 20b and 20c to fully secure the risers on the utility 50.

In some embodiments, a separate color coded cable 60 is coupled to each riser such that the cable 60 interconnects adjacent risers (not shown) along the length of the utility 50, as shown in FIG. 5J. In other embodiments, an additional color coded cable 260 is coupled to each riser 20a, 20b and 20c such that cable 260 interconnects each of the risers across the width 58 of the utility 50, as shown in FIG. 5K. Thus, in some embodiments cable 260 is positioned perpendicular to cables 60.

Referring now to FIG. 6, a plurality of risers 20 are shown as coupled to an underground utility 50. Each riser 20 is spaced from an adjacent riser 20 by an approximate distance 12, as previously discussed. In some embodiments, a color coded cable 60 is attached to the second end 14 of each riser 20 in a continuous manner. As such, the color coded cable interconnects each riser 20 with an adjacent riser 20. In some embodiments, a first cable 60a is coupled to the second end 24 of each riser so that the cable 60a is weaved between adjacent risers 20. In another embodiment, a second cable 60b is further weaved between adjacent risers 20 in a position opposite the first cable 60a. As such, the first and second cables 60a and 60b crisscross one another at a position approximately half way between adjacent risers 20. This interwoven pattern provides lateral and rotational support to the plurality of risers 20 thereby maintaining the position of the risers 20 relative to the underground utility 50.

Referring now to FIG. 7, a junction 120 of an underground utility 50 is shown. In some embodiments, a plurality of color coded cables 60a, 60b and 60c are provided to map a junction 120 of an underground utility 50. For example, in some embodiments a first color coded cable 60a is coupled to both a second end 24 of a first riser 20a and a second end 24 of a second riser 20b, where the second riser 20b is coupled to a first portion 50a of an underground utility 50, and the first riser 20a is coupled to a second portion 50b of an underground utility 50, the second portion 50b being perpendicular to the first portion 50a. Thus, the first color coded cable 60a is curved approximately 90 degrees to interconnect the first riser 20a and the second riser 20b.

Furthermore, a second color coded cable 60b is coupled to both the second end 24 of the first riser 20a and the second end 24 of a third riser 20c, wherein the third riser 20c is coupled to a third portion 50c of the underground utility 50, the third portion 50c being generally parallel to the first portion 50a and generally perpendicular to the second portion 50b. Thus, the second color coded cable 60b interconnects the first riser 20a and the third riser 20c in a generally straight configuration.

In some embodiments a third color coded cable 60c is coupled to both the second end 24 of the third riser 20c and the second end 24 of the second riser 20b. Thus, the third color coded cable 60c is curved approximately 90 degrees to interconnect the third riser 20c and the second riser 20b. One of skill in the art will appreciate that the current designs of the present invention may be modified and/or adjusted to accommodate a variety of means and methods for interconnecting adjacent risers via a color coded cable 60, in accordance with the spirit of the present invention. For example, in some embodiments a first and a second color coded cable are oppositely interweaved through adjacent risers along an underground utility. In other embodiments, the first and second color coded cables do not cross or interweave through adjacent risers, but rather are run in parallel on opposite sides of each riser. Finally, in some embodiments the first and second color coded cables are both interweaved and run in parallel along an underground utility.

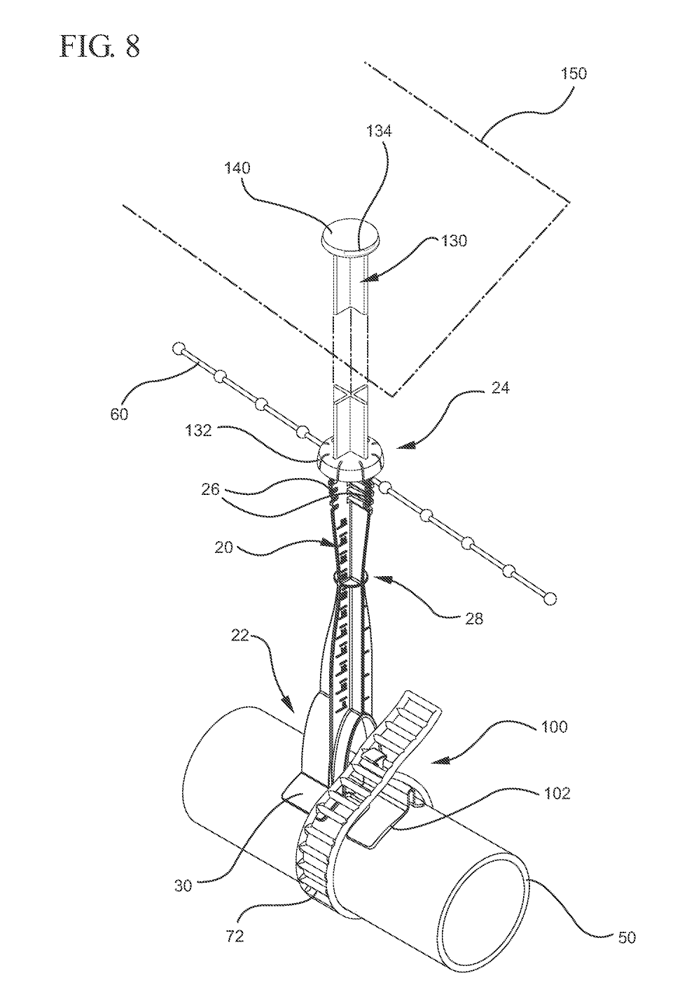

Referring now to FIG. 8, an underground marking system 10 is shown including a stanchion 130. In some embodiments it is desirable to provide an above-ground, visual indicator of an underground utility 50. Therefore, in some embodiments a stanchion 130 is coupled to the second end 24 of the riser 20. Stanchion 130 generally comprises a material having properties similar to the materials of the riser 20 and the color coded cable 60, as previously discussed. Additionally, in some embodiments stanchion 130 comprises a fluted, ribbed or flanged surface to provide lateral and rotational support along the length of the stanchion 130.

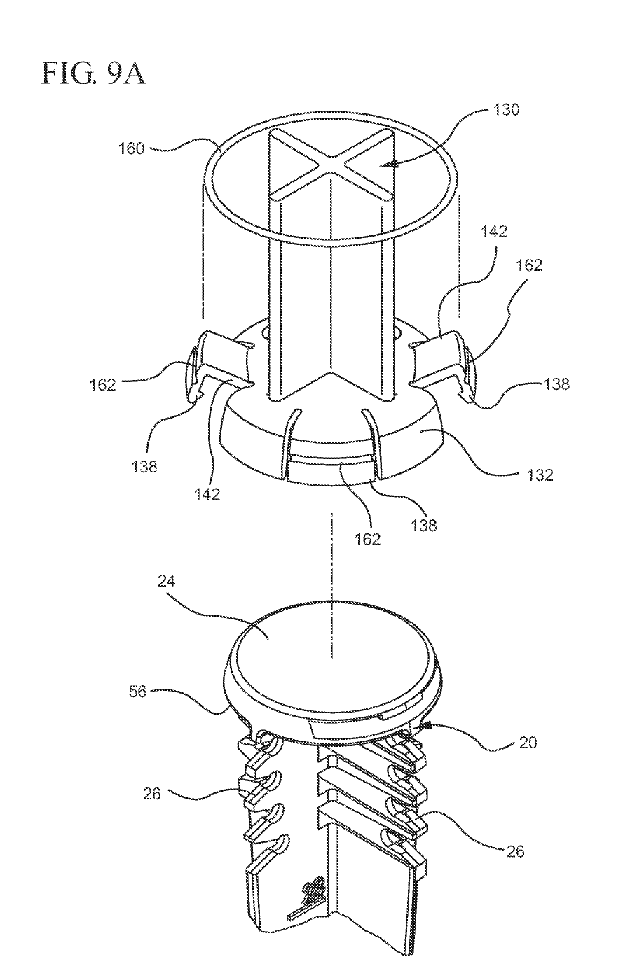

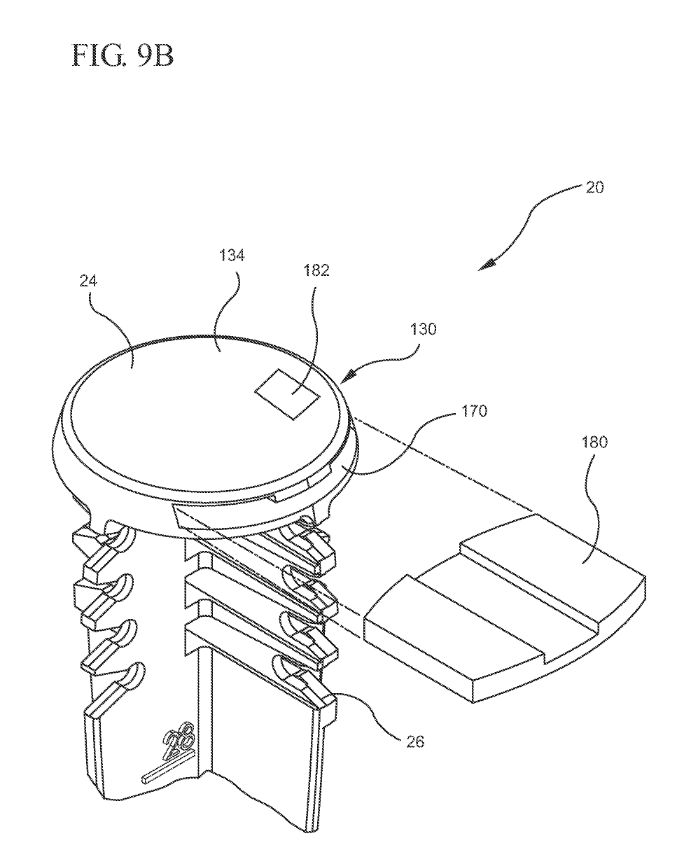

The stanchion 130 generally comprises a first end 132 and a second end 134. The first end 132 of the stanchion 130 is configured to directly couple to the second end 24 of the riser 20, as shown and discussed in greater detail in FIG. 9A. The second end 134 is configured to extend upwardly from the first end 132, such that the second end 134 is positioned at or above ground level 150. Thus, the second end 134 of the stanchion 130 provides a visual indicator of an underground utility 50 prior to excavation.

In some embodiments, the second end 134 of the stanchion 130 further comprises a cap 140 displaying information regarding the underground utility 50. For example, in some embodiments a written description of the underground utility is placed on a visible surface of the cap 140. In other embodiments, the cap is color coded as a visual indication of the class of underground utility 50. Still further, in some embodiments a directional marker is provided on the cap 140 to disclose a direction and/or orientation of the underground utility 50. Additional details regarding embodiments of the cap 140 are discussed in connection with FIGS. 9B through 11, below.

Stanchion 130 may comprise prefabricated lengths or may be cut to an appropriate length as required by the specific application. In some embodiments, the first end 132 of the stanchion 130 comprises means for directly and compatibly coupling to the stanchion 130 to the second end 24 of the riser 20. Referring now to FIG. 9A, in some embodiments of the present invention the first end 132 of the stanchion 130 comprises a plurality of fingers 138 configured to compatibly engage a recessed surface 56 of the second end 24 of the riser 20. In some embodiments, the first end 132 of the stanchion 130 comprises hinged fingers 142, wherein the hinged fingers 142 enable an opened and closed configuration of the plurality of fingers 138. Thus, in some embodiments the first end 132 of the stanchion 130 is coupled to the second end 24 of the riser 20 such that the plurality of fingers 138 engage the recessed surface 56 of the second end 24. Additionally, in some embodiments a ring or band 160 is placed within a groove 162 located on an outer surface of the plurality of fingers 138, thereby maintaining a closed position of the fingers 138.

In other embodiments, the second end 24 of the riser 20 is modified to include a set of threads (not shown) which threadedly couples a set of threads comprising the first end 132 of the stanchion 130. Finally, in other embodiments an adhesive material is utilized to attach the stanchion 130 to the riser 20.

Referring now to FIG. 9B, a second end 134 of the riser 20 or the stanchion 130 may include a compartment 170 for compatibly receiving and/or housing a reflector 180. The reflector 180 generally includes means for detecting the presence of the second end 24 and/or 134 via known detection techniques. For example, in some embodiments the reflector 180 comprises materials that are sensitive to known methods of detection. In other embodiments, the reflector 180 comprises circuitry enabling detection by known methods in the art. In some embodiments, the reflector 180 is detectible by at least one known method of detection, including but not limited to visual identification, sonar technology, global positioning satellite technology, radar technology, magnetometer technology, radiograph technology, electromagnetic technology, and thermal sensing technology. In other embodiments, the reflector 180 emits a detectable signal. Non-limiting examples of detectable signals include sound and wireless signal technologies.

In some aspects of the present invention, the reflector 180 is a global positioning satellite (GPS) transmitter that sends or “pushes” data, at regular intervals, to a server that analyzes the pushed data to determine the position of the reflector 180. A GPS receiver is then used to guide a user to the position of the reflector 180 and the associated underground utility 50. In some embodiments, the GPS transmitter is powered by an internal battery. In other embodiments, the second end 24 or 134 of the riser 20 or stanchion 130 further comprises a solar cell or panel 182 that is configured to continuously power the GPS transmitter 180. In other embodiments, a cap 140 or other fixture containing a battery and/or a solar cell 182 is coupled to the second end 24 or 134 of the riser 20 or stanchion 130 to provide power to the reflector 180. In some embodiments the GPS transmitter is powered by an internal battery which is continuously charged via a solar cell 182. Finally, in some embodiments the GPS transmitter is powered by the underground utility 50 via circuitry between the GPS transmitter and the utility.

In other aspects of the present invention, the location of the riser 20 is recorded and located using a GPS receiver. A GPS receiver is any of a variety of electronic devices that receive data from the Navstar satellites in order to determine positions on the earth's surface. Navstar satellites comprise a constellation of between 24 and 32 Medium Earth Orbit satellites that transmit precise microwave signals, which allow GPS receivers to determine precise geographic locations. Thus, in some embodiments a GPS receiver is temporarily placed near a riser 20 to record the longitude and latitude coordinates of the riser 20. Thereafter, the stored coordinates of the buried riser 20 are used in combination with a GPS receiver to locate the riser 20 and the respective underground utility 50.

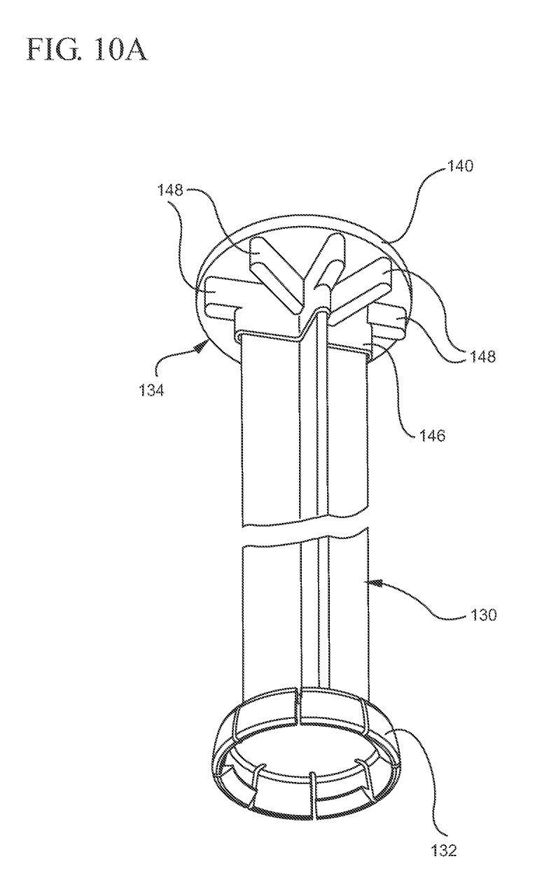

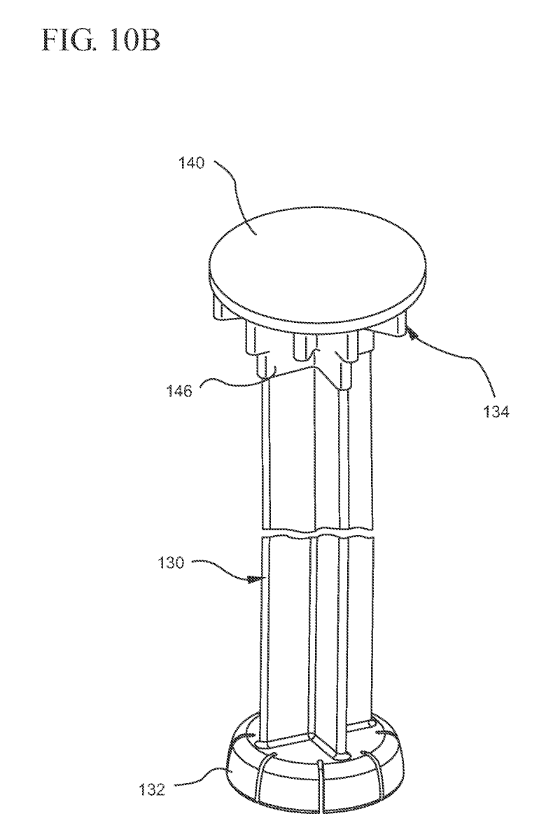

Referring now to FIGS. 10A and 10B, an embodiment of a cap 140 is shown as coupled to a stanchion 130. In some embodiments, the second end 134 of the stanchion is trimmed to achieve a desired stanchion height or length. Thus, a single stanchion 130 may be manufactured having a generic length that may be trimmed as required for a specific application. In some embodiments, a cap 140 is provided having a receptacle 146 shaped to receive the trimmed end 134 of the stanchion 130. In other embodiments, the cap 140 includes structural flanges 148 to provide additional rigidity to the cap 140. As such, the cap 140 is structurally capable of being stepped on or driven over in its above-ground position.

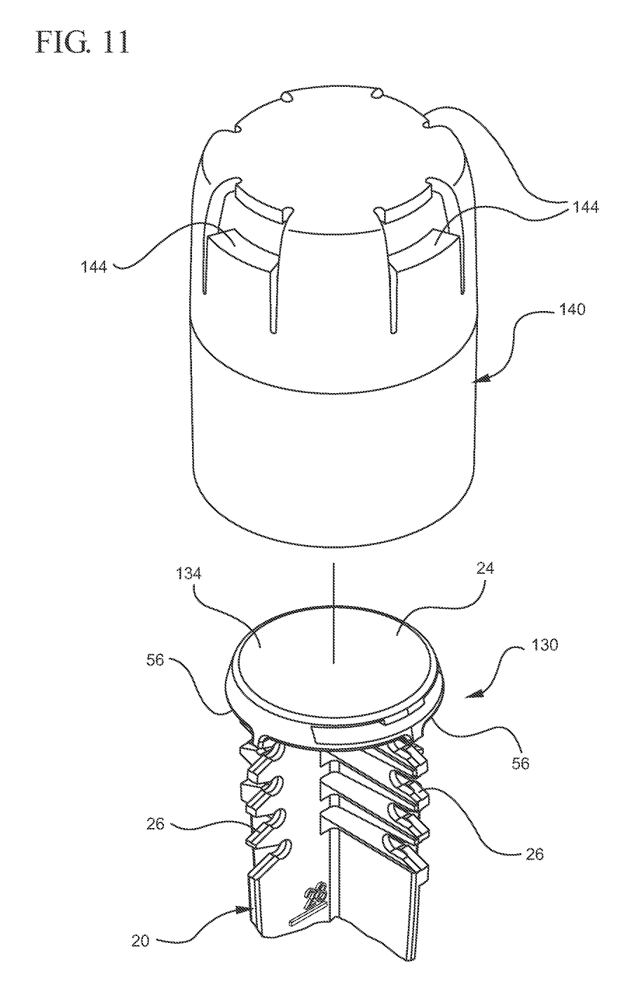

Referring now to FIG. 11, an embodiment of a cap 140 is shown as coupled to a second end of a stanchion 130 or riser 20. Cap 140 is generally comprised of a material compatible with above-ground or underground installation. The cap 140 compatibly engages the second end of the stanchion 130 or riser 20 such that a plurality of fingers 144 abuts a recessed surface 56 of the second end 134 or 24. Thus, the cap 140 interlockedly engages the stanchion 130 and/or riser 20. In some embodiments, the placement of the cap 140 prevents unintended removal or displacement of a reflector 180 (not shown) from the slot 170. In other embodiments, the cap 140 is color coded to indicate the type of utility or utilities to which the riser 20 and/or stanchion 130 is coupled. Finally, in some embodiments the cap 140 comprises material and/or means by which the cap 140 is located by detection methods and technologies known in the art.

Thus, as discussed herein, the embodiments of the present invention generally relate to a marking system for detecting underground utilities. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A system for marking an underground utility, the system comprising a plurality of risers, each riser having a first end and a second end, the first end of each riser having a contact surface to be affixed to a portion of the underground utility, the second end of each riser having an interface surface for receiving a colored cable, wherein the colored cable provides a visual indication of the underground utility.

2. The system of claim 1, further comprising a predetermined distance interposed between the contact surface and the interface surface of each riser.

3. The system of claim 1, further comprising a reflector attached to the second end of each riser.

4. The system of claim 3, wherein the reflective disk is detectable via at least one of a sonar technology, a global positioning satellite technology, a radar technology, a magnetometer technology, a radiograph technology, an electromagnetic technology, and a thermal sensing technology.

5. The system of claim 1, wherein a selected color of the colored cable corresponds to a color code representative of a specific type of underground utility.

6. The system of claim 3, wherein the reflector is positioned approximately within a plane of the ground surface.

7. The system of claim 1, further comprising a stanchion having a first end and a second end, wherein the first end of the stanchion is coupled to the second end of the riser, and the second end of the stanchion extends upwardly to a position proximal to a ground surface.

8. A method for marking an underground utility, the method comprising:
providing an underground utility;
coupling a first end of a first riser to a first portion of the underground utility;
coupling a first end of a second riser to a second portion of the underground utility;
spacing the first riser from the second riser at a predetermined distance;
interconnecting a second end of the first riser with a second end of the second riser with a colored cable; and
positioning the colored cable at a predetermined height above the underground utility, wherein the colored cable provides a visual indication of the underground utility.

9. The method of claim 8, further comprising coupling a reflector to the second end of at least one of the first and second riser, wherein the reflector is detectable via at least one of a sonar technology, a global positioning satellite technology, a radar technology, a magnetometer technology, a radiograph technology, an electromagnetic technology, and a thermal sensing technology.

10. The method of claim 8, further comprising selecting a color for the colored cable, the color of the colored cable corresponding to a color code representative of a specific type of underground utility.

11. The method of claim 8, further comprising coupling a first end of a stanchion to the second end of at least one of the first and second riser, wherein a second end of the stanchion extends upwardly to a position proximal to a ground surface.

12. The method of claim 11, further comprising coupling a reflective disk to the second end of the stanchion, wherein the reflective disk is detectable via at least one of a sonar technology, a global positioning satellite technology, a radar technology, a magnetometer technology, a radiograph technology, an electromagnetic technology, and a thermal sensing technology.

13. The method of claim 12, further comprising interconnecting the first and second risers with the colored cable such that the colored cable substantially spans the length of the underground utility at the predetermined height above the underground utility.

14. The method of claim 8, further comprising coupling a plurality of risers to the underground utility, the predetermined distance being interposed between adjacent riser of the plurality of risers, wherein the plurality of risers substantially spans a length of the underground utility.

15. A device for marking an underground utility, the device comprising a riser having a first end and a second end, the first end of the riser being coupled to the underground utility, and the second end extending upwardly from the underground utility, the second end having a surface configured to receive a colored marking cable at a predetermined height above the underground utility.

16. The device of claim 15, further comprising a retention mechanism to secure the first end of the riser to the underground utility.

17. The device of claim 16, wherein the retention mechanism is at least one of a strap, a belt, a chain, a tether and an adhesive.

18. The device of claim 16, wherein the retention mechanism comprises a receiving channel into which a portion of the underground utility is inserted and retained.

19. The device of claim 15, wherein the second end of the riser further includes a compartment for receiving a reflective disk.

20. The device of claim 15, wherein the surface configured to receive the colored marking cable comprises at least one of a channel, an indent, a protrusion, a groove, a notch, a hook, a plug, a receptacle, a cavity, a striated surface and a contoured surface.

21. The device of claim 15, wherein the second end of the riser further comprises a mounting surface for receiving a stanchion, the stanchion having a first end and a second end, the first end being coupled to the mounting surface, and the second end extending upwardly to a position proximal to a ground surface.
